(19) United States
(12) Patent Application Publication
(10) Pub. No.: US 2013/0184083 A1
(43) Pub. Date: Jul. 18, 2013

(54) Method for interactive logic fault tolerance in online game, and system and client for fault tolerance in online game

(71) Applicant: Wei Li, Shenzhen (CN)

(72) Inventor: Wei Li, Shenzhen (CN)

(73) Assignee: TENCENT TECHNOLOGY (SHENZHEN) COMPANY LIMITED, Shenzhen, Guangdong (CN)

(21) Appl. No.: 13/825,653

(22) PCT Filed: Nov. 4, 2011
(86) PCT No.: PCT/CN11/81787

§ 371 Date: Mar. 22, 2013

(30) Foreign Application Priority Data
Nov. 4, 2010 (CN) 201010536884.4

(51) Int. Cl. A63F 13/12

(52) U.S. Cl. CPC A63F 13/12
USPC 463/42

(57) ABSTRACT

The disclosure relates to the field of computer, and provides a method for interactive logic fault tolerance in an online game and a system for fault tolerance in an online game. The method includes the following steps: a client determines whether there is fault in the game data; the client sends a game data synchronization request to a game sever when it is determined that there is fault in the game data; the game server returns a game data synchronization response to the client, and the game data synchronization response comprises correct game data corresponding to the false game data; and the client updates game data of a game player according to the game data synchronization response. In embodiments of the disclosure, the client sends the game data synchronization request to the game sever when it is determined that there is fault in the game data, the game server returns the game data synchronization response to the client, and the client updates the game data of the game player according to the game data synchronization response returned by the game server, so that the client can also play a game by synchronizing the game data with the game server when there is fault in the game data.

### TECHNICAL FIELD

The present disclosure relates to the field of computers, and in particular to a method for interactive logic fault tolerance in an online game, and a system and a client for fault tolerance in an online game.

### BACKGROUND

FIG. 1 illustrates a method for interactive logic fault tolerance in an online game according to the prior art; a client and a game server achieve a purpose of fault tolerance by data matching in an interaction process: each time a game player performs an operation, the client sends the operation data to the game server, the game server performs logical processing on the received data, and returns the data logically processed to the client, if data of the client and the game server are matched successfully, then it is indicated that game data of the client and game data of the game server are consistent.

If the client does not receive the data returned by the game server, then the client can not perform the operation of the game player, such that data of the client and data of the game server are inconsistent, a logic status error is caused and a game can not continue.

### SUMMARY

In view of the above, the main purpose of the disclosure is to provide a method for interactive logic fault tolerance in an online game, a system for fault tolerance in an online game and a client for fault tolerance in an online game, so as to solve the problem that game data of a client is inconsistent with game data of a game server.

Embodiments of the disclosure are realized as follows.

A method for interactive logic fault tolerance in an online game includes the following steps:

a client determines whether there is fault in the game data of the client;

the client sends a game data synchronization request to a game sever when it is determined that there is fault in the game data of the client;

the game server returns a game data synchronization response to the client, the game data synchronization response comprises correct game data corresponding to the false game data; and

the client updates the game data of the client according to the game data synchronization response.

A system for fault tolerance in an online game includes:

at least one client configured to determine whether there is fault in game data, send a game data synchronization request to a game sever when it is determined that there is fault in the game data, receive a game data synchronization response returned by the game server, and update the game data of the at least one client according to the game data synchronization response; and

the game server configured to receive the game data synchronization request sent by the client and return the game data synchronization response to the client;

wherein the game data synchronization response comprises correct game data corresponding to the false game data.

A client for fault tolerance in an online game includes:

a data error determination unit configured to determine whether there is fault in the current game data of the client;

a data synchronization request sending unit configured to send a game data synchronization request to a game sever when the data error determination unit determines that there is fault in the game data;

a data synchronization response receiving unit configured to receive a game data synchronization response returned by the game server; and

a game data updating unit configured to update the game data of the client according to the game data synchronization response received by the data synchronization response receiving unit, wherein the game data synchronization response comprises correct game data corresponding to the false game data.

In embodiments of the disclosure, the client sends the game data synchronization request to the game sever when it is determined that there is fault, the game server returns the game data synchronization response to the client, and the game data synchronization response comprises correct game data corresponding to the false game data, and the client updates the game data of the game player according to the game data synchronization response returned by the game server, which solves the problem that game data of the client is inconsistent with game data of the game server, so that the client can play a game by synchronizing the game data with the game server when there is fault in the game data.

### BRIEF DESCRIPTION OF THE DRAWINGS

FIG. 1 shows a flowchart illustrating a method for interactive logic fault tolerance in an online game according the prior art;

FIG. 2 shows a flowchart illustrating a method for interactive logic fault tolerance in a universal online game according to one embodiment of the present disclosure;

FIG. 3 shows a structure diagram illustrating a client in a system for fault tolerance in an online game according to one embodiment of the present disclosure;

FIG. 4 shows a structure diagram illustrating a game server in a system for fault tolerance in an online game according to one embodiment of the present disclosure; and

FIG. 5 shows a structure diagram illustrating a system for fault tolerance in an online game according to one embodiment of the present disclosure.

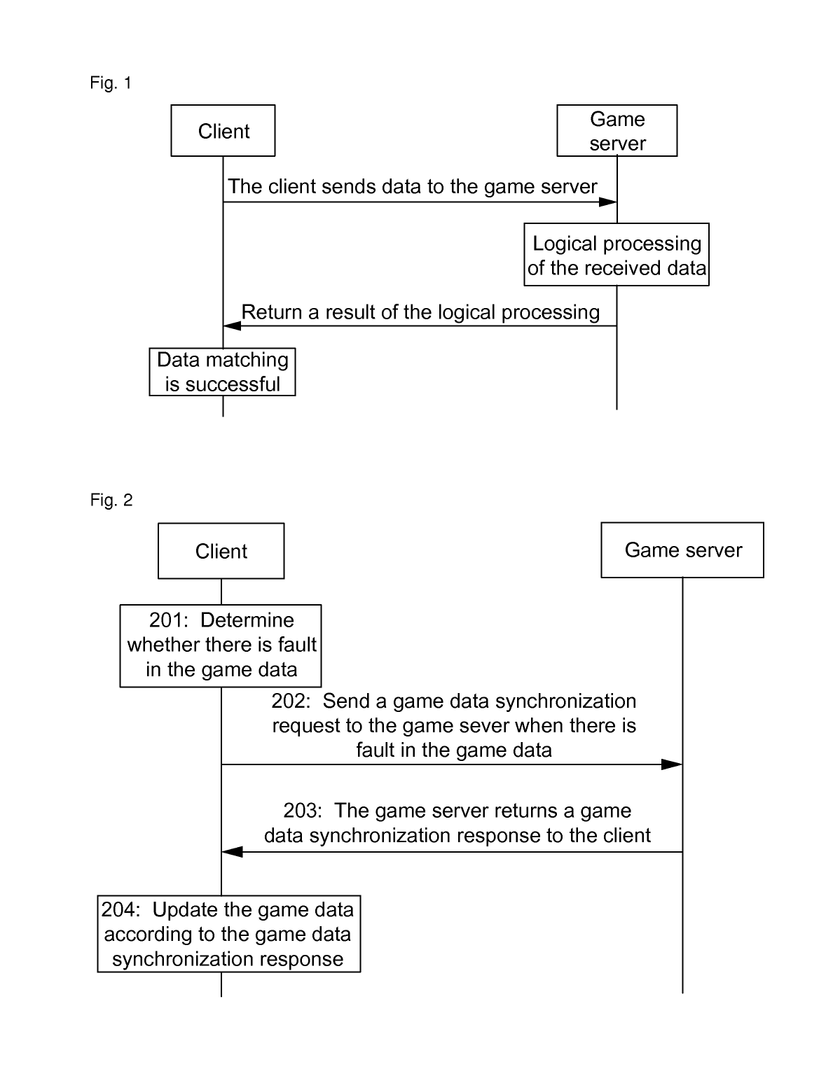

### DETAILED DESCRIPTION

To make the purpose, technical solution and advantages of the disclosure more clear and better understood, the disclosure will be further described in detail in combination with the drawings and embodiments hereafter. It should be appreciated that the specific embodiments described here are merely used to explain the disclosure rather than define the disclosure.

In embodiments of the disclosure, a client sends a game data synchronization request to a game sever when there is fault in the game data, and adjusts game data of the client by comparing the game data of the client with game data of the game server, so that an online game may continue.

A method for interactive logic fault tolerance in an online game includes the following steps: a client determines whether there is fault in game data of the client;

the client sends a game data synchronization request to a game sever when it is determined that there is fault in the game data of the client;

the game server returns a game data synchronization response to the client, and the game data synchronization response comprises correct game data corresponding to the false game data; and

the client updates the game data of the client according to the game data synchronization response.

A system for fault tolerance in an online game includes: at least one client configured to determine whether there is fault in game data, send a game data synchronization request to a game sever when it is determined that there is fault in the game data, receive a game data synchronization response returned by the game server, and update the game data of the client according to the game data synchronization response; and

the game server configured to receive the game data synchronization request sent by the client and return the game data synchronization response to the client;

wherein the game data synchronization response comprises correct game data corresponding to the false game data.

FIG. 2 shows a flowchart illustrating a method for interactive logic fault tolerance in a universal online game according to one embodiment of the disclosure, and the method specifically includes the following steps:

Step 201: a client determines whether there is fault in the game data.

As one embodiment of the disclosure, each time a game player performs an operation, a client sends an operation instruction to a game server, and the game server sends feedback information for the game operation instruction from the game server to client; if the client does not receive the feedback information for the game operation instruction from the game server, then the client determines that there is fault in the game data.

As another embodiment of the disclosure, the client sends a user data acquisition request to the game sever when the client can not determine whether the game data of the client is consistent with game data of the game server; after receiving the game data acquisition request, the game server returns a game data response to the client, and the game data response comprises game data requested by the user data acquisition request; the client compares the game data returned by the game server with the game data stored locally; and when the game data returned by the game server is inconsistent with the game data stored locally, the client determines game data corresponding to the operation instruction is false.

Step 202: the client sends a game data synchronization request to a game server when it is determined that there is fault in the game data.

Step 203: the game server returns a game data synchronization response to the client, and the game data synchronization response comprises correct game data corresponding to the false game data.

Step 204: the client updates game data of the client according to the game data synchronization response.

In embodiments of the disclosure, the client sends the game data synchronization request to the game sever when it is determined that there is fault in the game data, the game server returns the game data synchronization response to the client, and the game data synchronization response comprises correct game data corresponding to the false game data, and the client updates the game data of the game player according to the game data synchronization response returned by the game server, which solves the problem that game data of the client is inconsistent with game data of the game server, so that the client can also play a game by synchronizing the game data with the game server when there is fault in the game data.

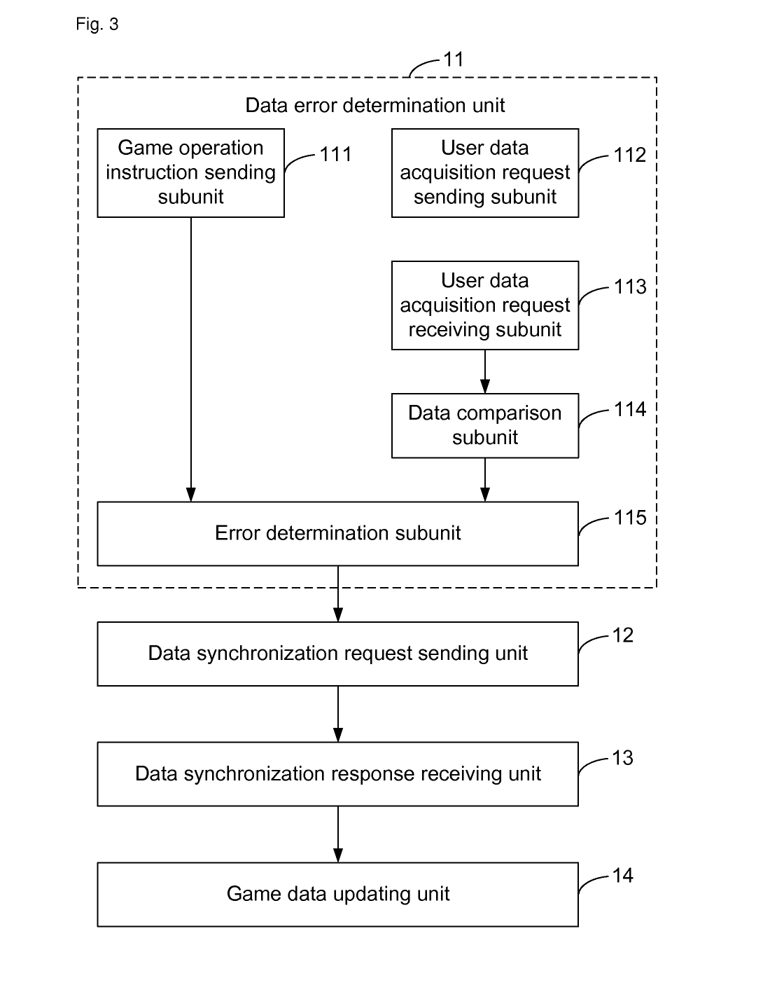

FIG. 3 shows a structure diagram illustrating a client in a system for fault tolerance in an online game according to one embodiment of the disclosure; to facilitate explanation, only portions related to implementation of the disclosure are shown. The client includes: a data error determination unit 11, a data synchronization request sending unit 12, a data synchronization response receiving unit 13 and a game data updating unit 14.

The data error determination unit 11 is configured to determine whether there is fault in the current game data of the client; and

the data error determination unit 11 can further include: a game operation instruction sending subunit 111 configured to send a game operation instruction to the game sever; a user data acquisition request sending subunit 112 configured to send a game data acquisition request to the game sever when the client does not determine whether game data of the client is consistent with game data of the game server; a user data acquisition request receiving subunit 113 configured to receive the game data sent by the game server; a data comparison subunit 114 configured to compare the game data returned by the game server with the game data stored locally; and an error determination subunit 115 configured to determine that game data corresponding to the game operation instruction is false when the client does not receive feedback information for the game operation instruction from the game server or the game data returned by the game server is inconsistent with the game data stored locally.

As one embodiment of the disclosure, each time a game player performs an operation, the game operation instruction sending subunit 111 of the client sends an operation instruction to the game server, and the game server sends feedback information for the game operation instruction to client; if the client does not receive the feedback information for the game operation instruction from the game server, then the error determination subunit 115 determines that there is fault in the game data.

As another embodiment of the disclosure, the user data acquisition request sending subunit 112 sends the user data acquisition request to the game sever when the client can not determine whether game data of the client is consistent with game data of the game server; after receiving the game data acquisition request, the game server returns a game data response to the client, and the game data response comprises game data requested by the user data acquisition request; the user data acquisition request receiving subunit 113 receives the game data sent by the game server; the data comparison subunit 114 compares the game data returned by the game server with the game data stored locally; and when the game data returned by the game server is inconsistent with the game data locally stored, the error determination subunit 115 determines game data corresponding to the operation instruction is false.

The data synchronization request sending unit 12 is configured to send a game data synchronization request to a game sever when the data error determination unit 11 determines that there is fault in the game data;

the data synchronization response receiving unit 13 is configured to receive a game data synchronization response returned by the game server; and

the game data updating unit 14 is configured to update game data of a game player according to the game data synchronization response received by the data synchronization response receiving unit 13, wherein the game data synchronization response includes correct game data corresponding to the false game data.

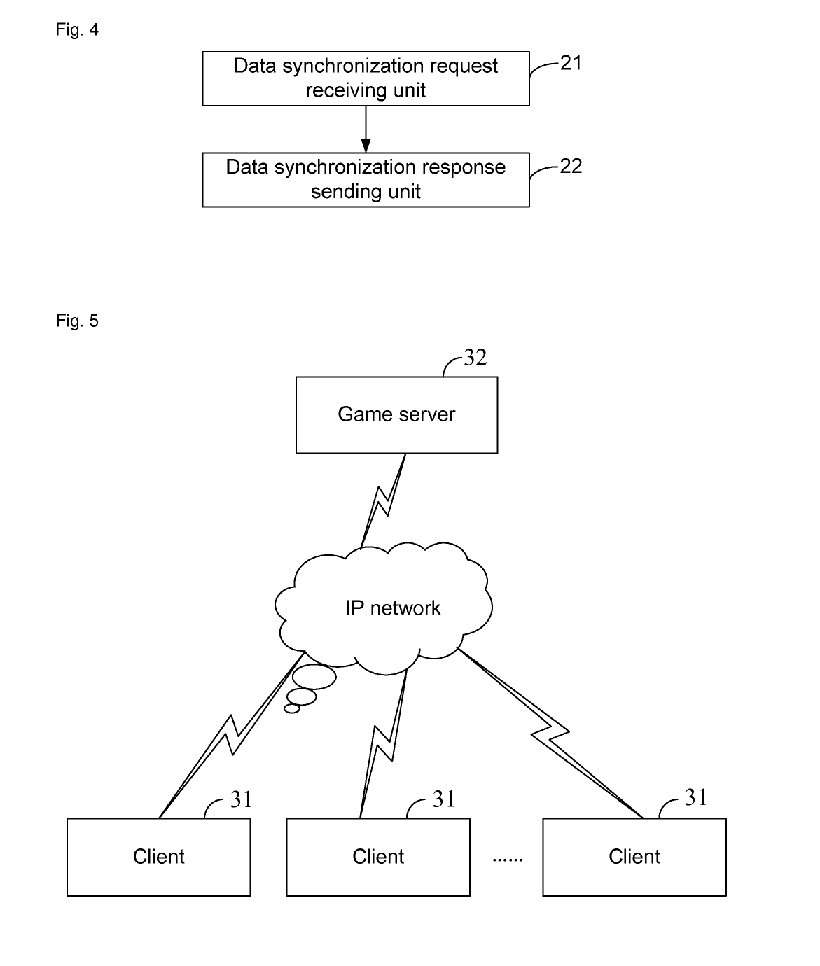

FIG. 4 shows a structure diagram illustrating a game server in a system for fault tolerance in an online game according to one embodiment of the disclosure; for illustrative purposes, only portions related to implementation of the disclosure are shown.

A data synchronization request receiving unit 21 is configured to receive a game data synchronization request sent by a client; and

a data synchronization response sending unit 22 is configured to return a game data synchronization response to the client.

Wherein the game data synchronization request is sent to the game server when the client determines that there is fault in the game data, and the game data synchronization response includes correct game data corresponding to the false game data.

In embodiments of the disclosure, the client sends the game data synchronization request to the game sever when it is determined that there is fault in the game data, the game server returns the game data synchronization response to the client, and the game data synchronization response comprises correct game data corresponding to the false game data, and the client updates the game data of the game player according to the game data synchronization response returned by the game server, which solves the problem that game data of the client is inconsistent with game data of the game server, so that the client can also play a game by synchronizing the game data with the game server when there is fault in the game data.

FIG. 5 shows a structure diagram illustrating a system for fault tolerance in an online game according to one embodiment of the disclosure, and the system specifically includes:

at least one client 31 is configured to determine whether there is fault in the game data, send a game data synchronization request to a game sever when it is determined that there is fault in the game data, receive a game data synchronization response returned by a game server 32, and update game data of a game player according to the game data synchronization response, wherein the game data synchronization response comprises correct game data corresponding to the false game data; and

the game server 32 is configured to receive the game data synchronization request sent by the client 31 and return the game data synchronization response to the client 31.

The above are only the preferred embodiments of the disclosure and are not intended to limit the scope of the present disclosure; any modifications, equivalent replacements, improvements or the like within the principle of the present disclosure shall fall within the scope of the disclosure.

1. A method for interactive logic fault tolerance in an online game, comprising:
determining, by a client, whether there is fault in game data of the client;
sending, by the client, a game data synchronization request to a game sever when it is determined that there is fault in the game data of the client;
returning, by the game server, a game data synchronization response to the client, the game data synchronization response comprises correct game data corresponding to the false game data; and
updating, by the client, the game data of the client according to the game data synchronization response;
wherein the step of determining, by a client, whether there is fault in game data comprises:
sending, by the client, a game operation instruction to the game sever; and
determining, by the client, that the game data corresponding to the game operation instruction is false when the client does not receive feedback information for the game operation instruction from the game server.

2. (canceled)

3. A method for interactive logic fault tolerance in an online game, comprising:
determining, by a client, whether there is fault in game data of the client;
sending, by the client, a game data synchronization request to a game sever when it is determined that there is fault in the game data of the client;
returning, by the game server, a game data synchronization response to the client, the game data synchronization response comprises correct game data corresponding to the false game data; and
updating, by the client, the game data of the client according to the game data synchronization response;
wherein the step of determining, by the client, whether there is fault in game data comprises:
sending, by the client, a user data acquisition request to the game sever when the client can not determine whether the game data of the client is consistent with game data of the game server;
returning, by the game server, a game data response to the client, and the game data response comprises game data requested by the user data acquisition request;
comparing, by the client, the game data returned by the game server with the game data stored locally; and
determining, by the client, game data corresponding to a game operation instruction is false when the game data returned by the game server is inconsistent with the game data stored locally.

4. A system for fault tolerance in an online game, comprising:
at least one client configured to determine whether there is fault in game data, send a game data synchronization request to a game sever when it is determined that there is fault in the game data, receive a game data synchronization response returned by the game server, and update the game data of the at least one client according to the game data synchronization response, wherein the game data synchronization response comprises correct game data corresponding to the false game data; and
the game server configured to receive the game data synchronization request sent by the client and return the game data synchronization response to the client
wherein the client comprises:
a data error determination unit configured to determine whether there is fault in the current game data of the client;
a data synchronization request sending unit configured to send the game data synchronization request to the game sever when the data error determination unit determines that there is fault in the game data;
a data synchronization response receiving unit configured to receive the game data synchronization response returned by the game server; and
a game data updating unit configured to update the game data of the at least one client according to the game data synchronization response received by the data synchronization response receiving unit, wherein the game data synchronization response comprises correct game data corresponding to the false game data;
wherein the data error determination unit comprises:
a game operation instruction sending subunit configured to send a game operation instruction to the game sever;
a user data acquisition request sending subunit configured to send a game data acquisition request to the game sever when the client can not determine whether the game data of the client is consistent with game data of the game server;
a user data acquisition request receiving subunit configured to receive the game data sent by the game server;
a data comparison subunit configured to compare the game data returned by the game server with the game data stored locally; and
an error determination subunit configured to determine that game data corresponding to the game operation instruction is false when the client does not receive feedback information for the game operation instruction from the game server or the game data returned by the game server is inconsistent with the game data stored locally.

5. (canceled)

6. (canceled)

7. The system for fault tolerance in an online game according to claim 6, wherein the game server comprises:
a data synchronization request receiving unit configured to receive the game data synchronization request sent by the client; and
a data synchronization response sending unit configured to return the game data synchronization response to the client.

8. A client for fault tolerance in an online game, comprising:
a data error determination unit configured to determine whether there is fault in the current game data of the client;
a data synchronization request sending unit configured to send a game data synchronization request to a game sever when the data error determination unit determines that there is fault in the game data;
a data synchronization response receiving unit configured to receive a game data synchronization response returned by the game server; and
a game data updating unit configured to update the game data of the client according to the game data synchronization response received by the data synchronization response receiving unit, wherein the game data synchronization response comprises correct game data corresponding to the false game data;
wherein the data error determination unit comprises:
a game operation instruction sending subunit configured to send a game operation instruction to the game sever;
a user data acquisition request sending subunit configured to send a game data acquisition request to the game sever when the client can not determine whether the game data of the client is consistent with game data of the game server;
a user data acquisition request receiving subunit configured to receive the game data sent by the game server;
a data comparison subunit configured to compare the game data returned by the game server with the game data stored locally; and
an error determination subunit configured to determine that game data corresponding to the game operation instruction is false when the client does not receive feedback information for the game operation instruction from the game server or the game data returned by the game server is inconsistent with the game data stored locally.

9. (canceled)
